(19) United States
(12) Patent Application Publication
(10) Pub. No.: US 2011/0192048 A1
(43) Pub. Date: Aug. 11, 2011

(54) Method and Device for Drying and Precondensing Impregnation Products which are Constituted of a Resin-Bonded Film-Type Web Material; Melamine-Free Impregnation Product

(75) Inventors: Paul Leitner, Tiefgraben (AT); Alois Gruber, Burmoos (AT); Johann Lienbacher, Bad Durrnberg (AT)

(73) Assignee: Kaindl Decor GmbH, Wals (AT)

(21) Appl. No.: 13/002,686

(22) PCT Filed: Jul. 8, 2009
(86) PCT No.: PCT/EP2009/058679

§ 371 Date: May 2, 2011

(30) Foreign Application Priority Data
Jul. 8, 2008 (DE) 10 2008 032 053.6

(51) Int. Cl. F26B 3/00

(52) U.S. Cl. 34/444

(57) ABSTRACT

In a process and a mechanism (10) for drying and pre-condensing impregnates (14), which are made of foil-type web material impregnated with synthetic resin, impregnate (14) is irradiated with microwaves. In that way, impregnates (14) can be obtained, which, although the impregnating resin is free of melamine, is appropriate for pressing with a base body made of wood material.

The invention has to do with a process and a mechanism for drying and pre-condensing impregnates that are made of foil-type web material that is impregnated with synthetic resin. Impregnates of that kind are used individually, or in the form of a laminated material formed from such impregnates, for example, to coat base bodies made of wood, for example in the manufacture of panels used to coat surfaces, for example in floorings.

A compound made up of natural fibers and/or synthetic fibers makes sense as the web material, not just based on the current level of technology, but also in combination with this invention; for example a mat, a fabric, or a web-like material of that type. Within that context, the concept of “foil-type” expresses that the web material is still flexible, even after drying and pre-condensing, in particular because it is thin, at around 0.1 mm. Preferably, the web material will be of paper, whose surface weight can be between approximately 25 g/m² and 300 g/m², in its non-impregnated condition. As is well known, a layer of paper of an impregnate, which is used to form the visual surface of an end product, is often printed with a desired pattern. Aminoplast and phenoplast resins are usually used as the impregnating resins.

It should be noted here that although, in conjunction with this invention, one always speaks of the “synthetic resin” or of the “impregnating resin”, in the singular, that resin can be a mixture of various synthetic resins.

In order to enable the penetration of the synthetic resin into the web material, the synthetic resin is mixed with a solution, for example water, the function of which is to lower the viscosity of the synthetic resin. If the web material is penetrated or impregnated with synthetic resin, the solution must be removed from the impregnate that is thus formed, before any further treatment is carried out, i.e. the impregnate must be dried. Because the synthetic resin used to impregnate the web material is usually thermosetting, condensation of the synthetic resin, i.e. increase of the molecular weight of the resin happens simultaneous to the drying of the impregnate. The pre-hardening is required, because it reduces the energy and time requirement for hardening the resin all the way through in further treatment, in particular in coating a base body made of wood material, with an impregnate of that kind.

In the current state of technology, for example making reference to EP 0 264 637 A1, impregnates of that kind are typically dried with heated air. In that process, the air gives off its energy to both surfaces of the impregnate, and from there, it travels into the inner part of the impregnate. As a result of the heating of the impregnate, the solvent also heats up, which is mixed with the resin, to enable impregnation, for example, water; and migrates to the surface of the impregnate, where it evaporates. Because the heat conducted into the interior of the impregnate, and the material transport of the solvent to its surfaces takes place diffusion-controlled, in the impregnate, there is a falling temperature gradient from the surfaces to the interior, and a falling solvent gradient from the interior to the surfaces. Because in industrial uses, drying should take place in the fastest possible time, in order to attain the highest degree of productivity, the drying air must have a very high temperature. The resulting high temperature difference between the surfaces and the inner part of the impregnate brings with it a lot of disadvantages.

If one has dried the impregnate to a predetermined “remaining humidity”, the impregnate will actually be drier on the surfaces and moister in its interior, than the value of the parameter, “remaining humidity” provides, over the entire cross-section of the impregnate. When the drying level that the impregnate shows on its surface allows the stacking of impregnates of that kind up to the point of further treatment, in coating of the base body, the result can be that the impregnates will stick together during storage (stacking), because the excess moisture diffuses from the inner part of the impregnate to the surfaces, and makes the resin sticky there, again. That effect limits the maximum storage time of the impregnates.

However, due to the simultaneous condensation of the synthetic resin, an increase in the drying level, in other words, a reduction of the remaining moisture, which could hinder that effect, is not easy to attain. In particular, the condensation level rises to an undesirable degree when heavy drying is done due to the great effect of heat on the surfaces. Because that highly condensed layer increasingly becomes fixed, due to the increase of the molar mass during drying, a compact layer forms on the surface, even though moisture continues to penetrate from the interior of the impregnate to the surface. The steam pressure in the interior of the material thus continuously rises, and ultimately penetrates the resin layer that has already hardened on the surface. Steam bubbles and/or craters form. When the craters are opened, dust forms. That dust, which consists of extra-hardened resin, loses its attachment to the web material and distributes itself in the drying air. That leads to the facility being contaminated, and to a reduced resin yield. In extreme cases, due to the heat effects on the surface, the resin layer will become so pre-hardened, that in further treatment, the viscosity of the resin is so high, that the formation of a decorative surface is seriously disrupted, and for example through too low resin flow in further treatment, open poor surfaces are formed. In addition the transparency of the resin can be detrimentally affected, because gel particles form, that no longer adhere to the other resin matrix, and thus remain as optical defects in the resin composite.

WO2007/065222 A1 attempts to prevent the disadvantages that have been described, using radiation drying in the form of near infrared radiation (NIR radiation). In practice, however, it has been shown that that process has considerable disadvantages with respect to conventional heated air drying. A big disadvantage of the NIR drying process is the strong dependency of the level of dryness on the color of the impregnation. That leads, in particular, during the drying of multi-colored decorative paper, to results that are not acceptable. In addition, another disadvantage is the requirement to equip the drying channel with a number of reflectors which are supposed to improve the energy yield of the NIR radiation, through multiple use. Those reflectors are continuously contaminated by condensate leaving, and the formation of layers, so that an efficient process cannot be maintained over time. Already due to these two disadvantages, NIR drying—particularly in industrial, continuous use—is not economically efficient.

With that in mind, the task of this invention is to provide a process of the generic type, in which a more even drying of the impregnate, and a more even pre-condensation of the synthetic resin can be attained.

According to the invention, this task is solved by a process of the type described at the beginning, in which the foil type web material penetrated with synthetic resin is radiated in a treatment mechanism, using microwaves. It has been shown that microwave radiation, in contrast to the NIR-type radiation, is absorbed by the web material penetrated with synthetic resin, independent of the specific coloration of the surface, indeed over the entire thickness of the web material, essentially with the same absorption level. In that way, heating the interior of the impregnate does not require that energy be transported from the surface of the web material; rather, there is an essentially constant temperature profile over the entire thickness of the material. At the most there can be local cooling on the surface of the impregnate, caused by the condensation that takes place there, of the solvent. However, that cooing is continuously equalized by the heated solvent brought in from the interior of the impregnate. As a result of that, the impregnate dries over its entire thickness essentially evenly, so that, when the appropriate dryness is reached on the surfaces, for storage, it is ensured that at least that dryness level also will be in the inner part of the impregnate, and prevents the resin from becomes sticky again from solvent material diffusing from the inner part.

At the same time it is ensured that also the pre-condensation is performed essentially evenly over the entire thickness of the impregnate. Furthermore, the rather low temperature on the surfaces ensures that that part of the resin, that is decisive for the quality of the surface in the further processing, has a sufficiently low viscosity to be fully hardened as a closed surface without the formation of pores, entrapment of gel particles or similar defects to the quality of the surface.

At this point it should be noted that the use of microwave radiation is generally known from WO 2006/056175 A1 for the purpose of drying fiberboard. However, these fiberboards are considerably thicker than the foil-type web material according to this invention. In addition, they must be exclusively dried, while, based on the invention, also the simultaneous pre-condensation of the synthetic resin must be taken into account.

As has already been mentioned, the impregnates used according to the invention have the characteristic of being sticky, in particular when the synthetic resin, with which the web material has been impregnated, is still moist. Residues attaching to lead elements, in particular synthetic resin and fiber material connected to it, can however, over the long-term, lead to defects on the product surface, or even to the web material tearing. In order to prevent impurities of that kind in the treatment mechanism, it is thus suggested that the web material be led through the treatment mechanism without contact occurring, preferably by means of at least one air cushion, which can be produced for example using nozzle boxes.

The air ejected from those nozzle boxes can also be used to lead away the moisture escaping from the web material. For that purpose, there need not be any additional fans; rather, moisture can be exclusively lead away by the air emitted by the nozzle boxes. That simplifies and makes less expensive the total setup of the treatment mechanism.

If the air emitted from the nozzle boxes is heated, it can take on more moisture per unit of volume, and be transported away. However, given the background of the explanations provided, it makes sense that the temperature of the air cushion should not be so high that over-drying and over-condensation of the surfaces of the web material occurs.

The air admitted from the nozzle boxes, according to the invention, is to be used solely for transporting off the moisture from the web material, and not to be used to heat the impregnate. That results in, based on the invention, considerably less quantities of air having to be used. That also results in correspondingly lower flow velocities on the surfaces of the web material. For that reason, the process of the invention does not run the danger of aerosol forming on the surface of the web material and being transported off from the surface. That also contributes to the reduction of impurities and contamination in the treatment mechanism.

Due to the high saturation of the air that is transported away with moisture, and simultaneously the absence of surface aerosols that form layers, in addition, for the process of the invention, it is possible to condense the moisture transported away from the surface of the web material in the subsequent step, and to thus regain it. The condensate contains volatile low molecular parts of the impregnating resin, which can be put back into the production process. In that way, the material and energy efficiency of the process that is the basis of the invention is further increased. In addition, waste gas with organic substances is reduced, whereby waste gas purification is assisted, and does not have to be as big.

In a further embodiment of the invention, it is proposed that the treatment mechanism comprises a plurality of microwave radiation units. The frequency of the microwave radiation radiated from the radiation units, for example, is between 900 MHz and 18 GHz, and preferably 2.45 GHz. That plurality of radiation units can be used to attain various advantageous effects. For example, an even more even drying and pre-condensation of the impregnate can be attained, when the microwave radiation units are set up on both sides of the web material. In addition, or as an alternative, the increasing drying and condensing levels of the impregnate in the transport direction of the impregnate through the treatment device can be taken into account, by the intensity of the microwave radiation radiated from the microwave radiation units in the transport direction of the web material decreasing, due to the treatment device, or varying in some other way.

However, surprisingly, it has been shown that through the process according to the invention, drying is not only more even, but is also faster. The result of that is that the pre-condensation level of the synthetic resin after drying is lower than it is in traditional drying processes.

However the even drying enables the manufacture of impregnates with particularly low levels of condensation, without those impregnates having to have an adhesion tendency. For that reason, less solvent has to be mixed into the synthetic resin before impregnation of the web material, to ensure a sufficient high condensation level at the conclusion of drying. Based on the invention, more viscous resins can be used, than possible according to the prior art. That is in particular advantageous based on the energy saved, compared with that which would have to traditionally be used, to again remove the additionally supplied moisture from the impregnate. The viscosity of the resin can, for example, be between approximately 20 mPAS and approximately 700 mPAS, but preferably will be between approximately 50 mPAS and approximately 300 mPAS (measured using a Brookfield viscosity meter with a measuring temperature of 25° C.).

However, that effect can also be used to manufacture an impregnate using a synthetic resin, that does not contain melamine resin, but rather, exclusively contains urea resin. That is of advantage, due to the high costs associated with using melamine resin. In the use of traditional drying processes, no impregnate could be manufactured based solely on urea resins, due to the unavoidable high condensation level, which impregnate had enough flow capability, to have a sufficient adhesion force with respect to a base body, during a subsequent treatment in a coating press. Surprisingly, it has been shown, however, that the same impregnates, after drying using the process of the invention, have such a low pre-condensation level, that the urea resins have such a high flow capability, that between the impregnate and the ground body, sufficient adhesion could be attained. According to another aspect, the invention thus refers to a melamine resin-free impregnate.

It should be noted that the following resins can be used as the impregnating resins: urea formaldehyde resin, melamine formaldehyde resin, melamine urea formaldehyde resin (MUF), melamine urea phenol formaldehyde resin (MUPF), phenol-formaldehyde resin (PF), Tannin resins, resorcinol formaldehyde resins, and silicone resins.

The invention is, in what follows, explained in more detail, using an example. It represents:

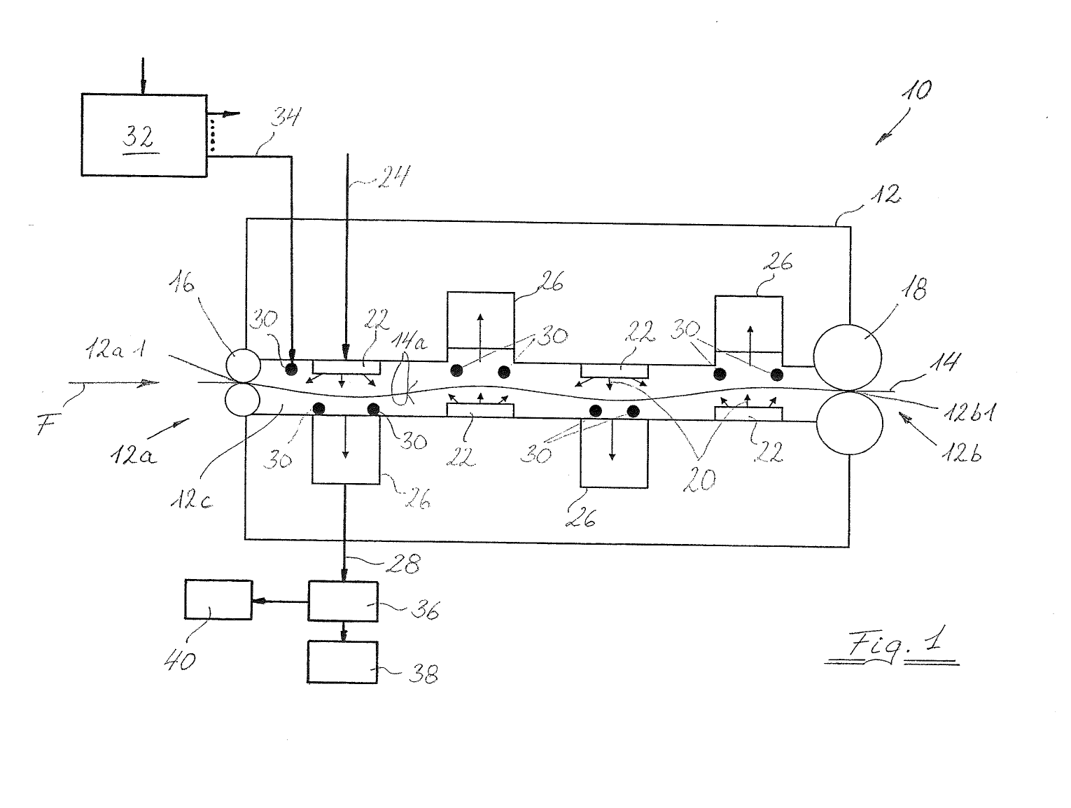

FIG. 1 a schematic representation of a treatment mechanism according to the invention, using which the process according to the invention can be carried out.

In FIG. 1, a treatment mechanism according to the invention is described, in very general terms, with 10. It comprises a housing 12 with an input 12a, through which impregnate 14 enters the housing 12, and an exit 12b, through which the impregnate 14 again exits the housing 12. The entry 12a, as well as the exit 12b, are formed from a Nip 12a1 and/or 12b1, i.e. in a slot, which forms a pair of rollers 16 and/or pair of rollers 18 between it. The height of that slot 12a1 and/or 12b1 is slightly larger dimensioned, than the thickness of the impregnate 14, and, for example, is approximately 0.1 mm.

In the interior space 12c of the housing 12, the impregnate 14 is led between the entry 12a and the exit 12b, using a cushion of air 20 without contact. That air cushion 20 is created by nozzle boxes 22, in which, over an access line 24 (in FIG. 1, only the access line 24 of the nozzle box 22 at the far left is represented) air from a fan (not represented here) is led. The air is again led from the inner space 12c of the housing 12, through ventilation air boxes 26, through ventilation air lines 28 (in FIG. 1, only the ventilation line 28 of the far left ventilation box 26 is represented).

In addition, in the inner space 12c of the housing 12, a plurality of microwave antennas 30 are set up, which irradiate the impregnate 14 with microwaves. The microwave radiation is absorbed essentially evenly by the moisture contained in the impregnate 14. The result of that is that the moisture warms up, and also the impregnate 14, including the synthetic resin, with which the impregnate 14 is penetrated. The moisture evaporates on the surfaces 14a of the impregnate 14, and a moisture gradient results. As a result of that moisture gradient, moisture diffuses also from the inner part of the impregnate 14 to the surfaces 14a, and evaporates there. However, it is important that the temperature is substantially constant over the entire thickness of impregnate 14, because that causes an even pre-condensation the resin in the impregnate 14.

In order to improve the evenness of the absorption of the microwave radiation, the microwave antennas 30 are set up on both sides of the impregnate 14, meaning, in the representation of FIG. 1, above and also below the impregnate 14. In addition, the energy led to microwave antennas 30 can be separately set by the control unit 32 for each individual microwave antenna 30, and led over an access line 34 (in FIG. 1, only the access line 34 for the far left positioned antenna 30 is represented). That allows, in the interior space 12c of the housing 12, a desired radiation intensity profile to be set with a varying radiation intensity in the transport direction F of the impregnate 14; for example, a profile with a decreasing radiation intensity, from input 12a to exit 12b.

Also, as represented in FIG. 1, the nozzle boxes 22 are not arranged just under the impregnate 14, but rather, alternating above and below. The same applies also for the ventilation air boxes 26. The air admitted from the nozzle boxes 22 is not only used to carry and led the impregnate 14 in a contact-free manner, but also to remove moisture that evaporates from both surfaces 14a of the impregnate 14. The moisture-saturated air is collected by the ventilation air boxes 26, and led over the ventilation lines 28 to a condensation mechanism 36, which condenses the moisture and leads it to a collection container 38, while it conducts the dehumidified waste air to a waste gas treatment unit 40. The condensate collected in the collection container 38 can be led back into the production process.

1-13. (canceled)

14. A process for drying and pre-condensing impregnates, that are made up of foil-type web material that is penetrated with synthetic resin, which is mixed with a solvent to enable it to penetrate the web material, wherein the impregnate is irradiated with microwaves to dry it in a treatment device.

15. The process of claim 14, wherein the impregnate is moved without contact through the treatment device.

16. The process of claim 14, wherein moisture led away from a surface of the impregnate is condensed in a subsequently located condensation device.

17. The process of claim 14, wherein the treatment device comprises a plurality of microwave radiation units.

18. The process of claim 17, wherein the microwave radiation units are set up on both sides of the impregnate.

19. The process of claim 17, wherein an intensity of microwave radiation given off by the microwave radiation units decreases in a direction that is the same as a movement direction of the impregnate through the treatment device.

20. The process of claim 14, wherein the web material is a composite made of at least one of natural fibers and synthetic fibers.

21. The process of claim 14, wherein the web material is paper.

22. The process of claim 14, the synthetic resin is a thermosetting synthetic resin.

23. The process of claim 14, wherein the web material is penetrated with a synthetic resin, the synthetic resin having a viscosity of between approximately 20 mPas and approximately 700 mPas as measured with a Brookfield viscosity meter, at a measurement temperature of 25° Celsius.

24. The process of claim 15, wherein the impregnate is moved without contact through the treatment device using at least one air cushion.

25. The process of claim 20, wherein the web material is selected from the group consisting of a fabric, a mat, and a web.

26. The process of claim 22, wherein the synthetic resin is an aminoplast resin or a phenoplast resin.

27. The process of claim 23, wherein the synthetic resin has a viscosity of between approximately 50 mPas and approximately 300 mPas as measured with a Brookfield viscosity meter, at a measurement temperature of 25° Celsius.
